(19) United States
(12) Patent Application Publication
(10) Pub. No.: US 2021/0012655 A1
(43) Pub. Date: Jan. 14, 2021

(54) Pedestrian mat and traffic light system

(71) Applicant: Fabion O'brain Reeves, Los Angeles, CA (US)

(72) Inventor: Fabion O'brain Reeves, Los Angeles, CA (US)

(21) Appl. No.: 16/505,357

(22) Filed: Jul. 8, 2019

(30) Foreign Application Priority Data
Jul. 8, 2019 (US) 62918520

(51) Int. Cl. G08G 1/07; G08G 1/005; G08G 1/095; G06Q 20/08

(52) U.S. Cl. CPC G08G 1/07; G06Q 20/085; G08G 1/095; G08G 1/005

(57) ABSTRACT

The pedestrian crossing mat's vital components includes various layers such as a tactile surface pattern layer, analog indicator, motion sensor, solar receptors and light beams to improve basic pedestrian crossing. Light configuration gives greater visibility for pedestrians and drivers; and also improves night vision with light barriers during the process of pedestrian crossing. The traffic light system is a 4 sided flat surface with 9 frames on all sides. It works with a solar panel cap, programmable LED traffic signals which allows for greater visibility by the positioning of the traffic post and mapping. Complementing the traffic system is the zebra crossing, consisting of caution blinkers, LED and laser projecting vertical and horizontal beams (strobes), which give greater illumination for traffic signals from dusk till dawn, thus providing efficient pedestrian safety. The hands free pedestrian mat and traffic light system also promotes a cleaner environment.

### DETAILED DESCRIPTION OF THE INVENTION

The pedestrian mat and traffic light system is a combination of three systems consisting of a fixed technologically enhanced mat and lights system made up of seven vital layers and a zebra system. The traffic light system is a display post controlled and monitored by a motherboard, molded waterproof with materials such as metal, aluminum, durable rubber, ballistic glass, and flexible plastic.

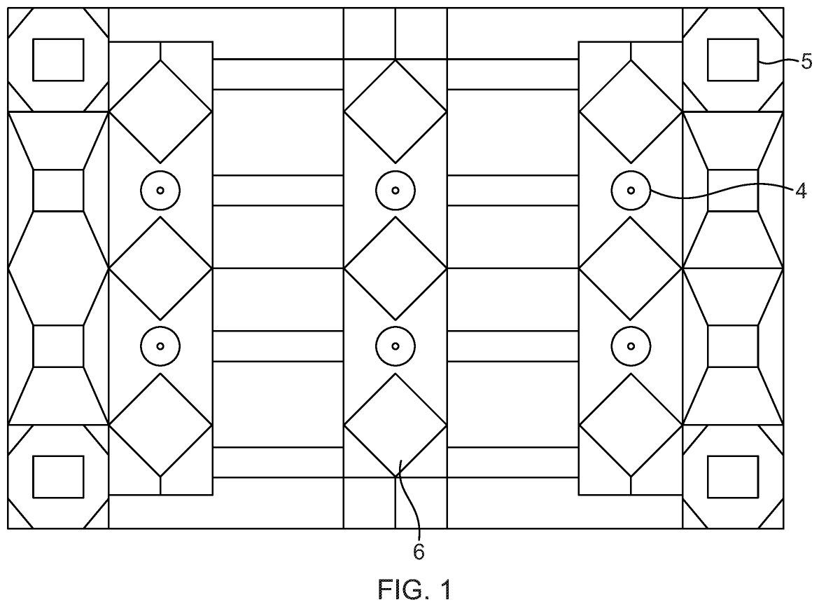

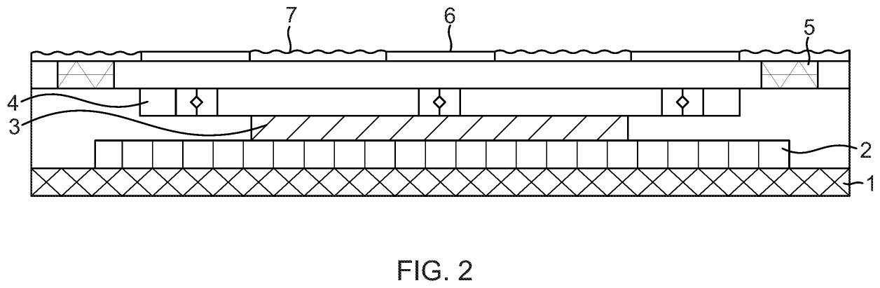

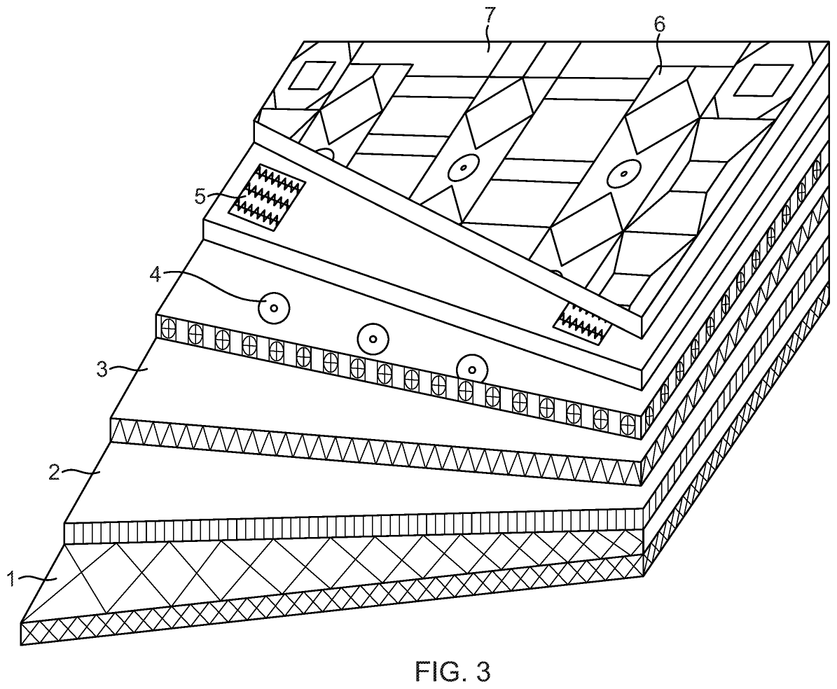

Beginning with the pedestrian mat (FIG. 3) the first layer from the bottom up called, (1) the activator layer consists of the off/on switch which turns on the device. (2) Indicates the weight sensor layer which determines weight in pounds to compliment the activator. (3) Indicates the analog electronic which assists in the feeling of the actual activation of the mat on a “WALK” signal. (4) Indicates the laser motion sensor which is used to sense any motion on top of the mat to wake it from sleep mode. (5) Indicates LED/and laser sky beam (strobes) which are used mainly at night to highlight pedestrians. Green strobes mean “Go” including an analog rhythm; yellow strobes mean crossing is in effect and red strobes means wait time is in effect. (6) Indicates the solar receptor which is an option based on the geographical location. And (7) indicates the Tactile surface pattern layer which is used for the visually impaired and for pedestrian safety

Activating the pedestrian mat requires the distribution of physical weight to “CALL” after a laser motion sensor reads the surface for activity and wakes the mat. Upon activating the “CALL BUTTON” the mat sends four rhythmic mini sky beams about seven feet in the air from the four corners of the mat while the pedestrian awaits the crosswalk signal. Green strobes means “GO” including an analog rhythm, yellow strobes mean crossing in effect, and red strobes mean wait time. Independently, an audio device may be used to compliment the visually impaired. The pedestrian crossing mat may be powered by electricity or solar.

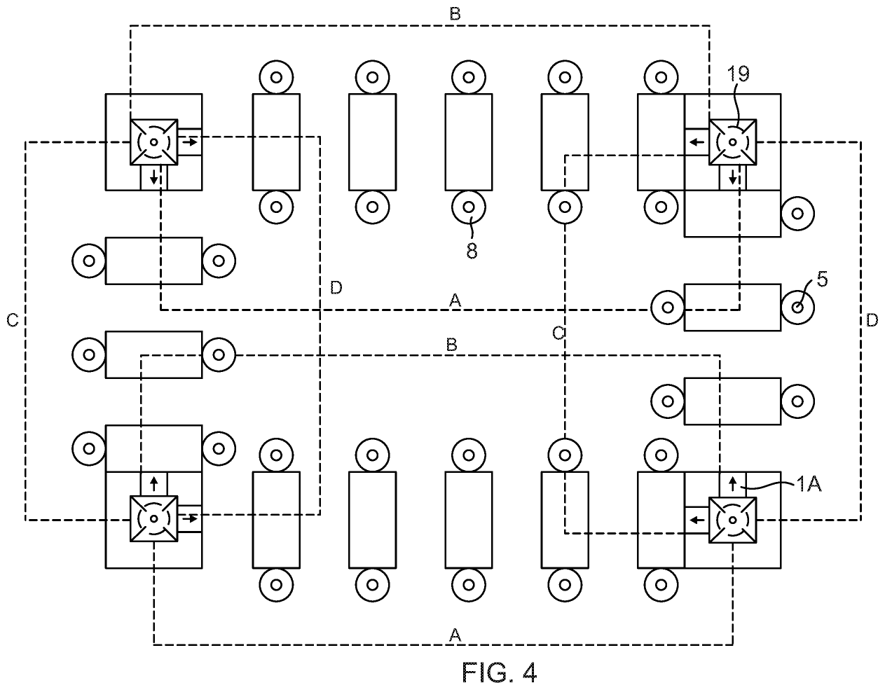

The zebra system (FIG. 4) is synchronized with the pedestrian mat and is designed to use vertical light barriers in red, yellow, and green to guide as a safety feature.

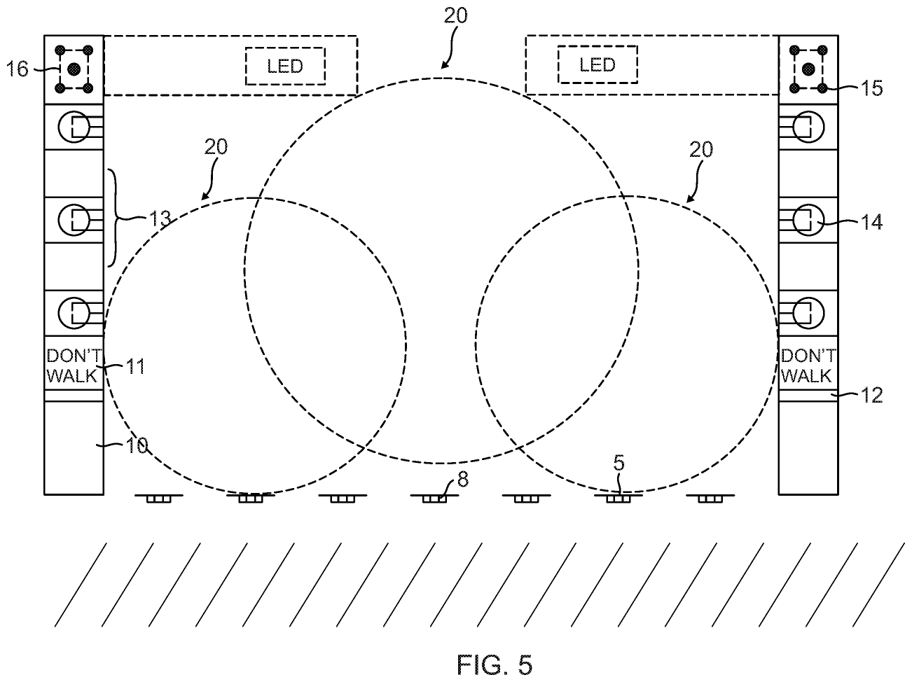

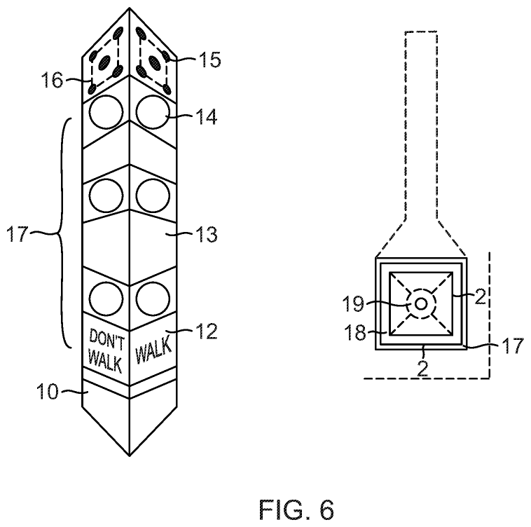

The traffic light post display system (FIG. 5-6) is a four sided flat surface with nine frames on all sides with two light and sign attachment options. From the bottom up, (10) allows for optional emergency storage compartment. (12) Four eye level High definition cameras about 12-15 feet at every angle. Then (11), the standard “WALK”, “DON'T WALK,” “WAIT” with real picture format and audio. (13) contains display screens for optional high speed traffic camera or program use like time, weather, etc. (14) are timed led and laser beams used from dusk to dawn to compliment (17) synchronized six frame solid traffic post light system. (15) and (19) are for optional lamp, lights and sign installment. (20) Is a hologram display. (16) is a solar panel cap or an optional lightweight aluminum design. And (18) contains the programmable LEDs allowing for greater distance of visibility. For example, (FIG. 4) driving towards the traffic intersection and before crossing the intersection the traffic signals A, B, C & D displays are visible four times from the traffic pest signals on the left and right of the intersection.

I claim:

1) A pedestrian mat and traffic light signal system, comprising: a call system inside a mat and is activated by a pedestrian when pressure is applied on the mat. A command is relayed to the traffic controller for the activation of the pedestrian crossing and zebra system. 2) The system of claim 2, comprising an analog electronics inside the mat with three variations of vibrations synced with the “CALL” and “GO” button signal. 3) The system of claim 3, comprising a weight sensor for smart sleep/wake mode. 4) The system of claim 4, comprising laser motion sensor sync with the weight sensor. 5) The system of claim 5, comprising LED and mini laser sky beam configured to be programmed to red, green, yellow and any color tone effects, flash and fade at set speeds. 6) The system of claim 6, wherein the solar receptors are configured inside the mat to use sun power as an optional energy source for the pedestrian mat. 7). The system of claim 7, comprising tactile mat pattern.

2. The system of claim 1, further comprising the zebra crossing system for pedestrian safety. 1) The system of claim 8, comprising the zebra system with vertical LED and laser lights with solar receptors and caution blinkers intertwined around the edges of the receptors. In communication with the traffic control the beams are activated and projected in a set pattern. 2) The system of claim 8, comprising a light pattern wherein the mini beams are configured to be programmed to r d, green, yellow and any color tone effects. Flash and fade are set speeds; associated with the pedestrian mat and traffic light signal system. 3. The system of claim 1, further comprising the traffic light signal system for driver and pedestrian safety. 1) The system of claim 10, traffic light post system lower metal design frame with optional storage compartment for emergency. 2) The system of claim 11, audio and visual signals for wait time, during a call request and before a walk signal. “WALK,” “DON'T WALK,” “WAIT.” “PLEASE WAIT UNTIL DIRECTED TO WALK,” “PREPARE TO WALK,” “BE SURE TO WATCH AND LISTEN FOR TRAFFIC,” and “WALK SAFELY.” 3) The system of claim 12, At about 12-15 feet are civilian eye level high definition face recognition cameras in four angles.

4) The system of claim 13, optional high speed camera placement or programmable displays. 5) The system of claim 14, horizontal LED and laser beam with programmable color variations. 6) The system of claim 15, optional arm, lamp, or sign installment. 7) The system of claim 16, is a solar panel cap or an optional lightweight aluminum design with vents. 8) The system of claim 17, removable protective polymer or ballistic glass.

9) The system of claim 18, programmable LED traffic light signal, directional mapping and digital advertising board. 10) The system of claim 19, traffic light frame with optional overhead light and additional installments.

11) The system of claim 20, programmable hologram display.

12) The system of claim, comprising a built in computer brain that collects data from automated vehicles and manage.

13) The system of claim, comprising a secondary Department of Motor Vehicle database in the traffic light system on satellite backup.

14) The system of claim, comprising a software design to manage the complete pedestrian and traffic light system.

15) The system of claim, comprising the control and monitor X-ray scanning of auto vehicles upon entering and leaving the traffic light system zones.

16) The system of claim, comprising a built in universal currency payment processing system.
